(19) United States
(12) Patent Application Publication
(10) Pub. No.: US 2020/0183496 A1
(43) Pub. Date: Jun. 11, 2020

(54) INFORMATION PROCESSING APPARATUS AND INFORMATION PROCESSING METHOD

(71) Applicant: SONY CORPORATION, TOKYO (JP)

(72) Inventors: KENJI SUGIHARA, KANAGAWA (JP); MARI SAITO, KANAGAWA (JP)

(21) Appl. No.: 16/633,227

(22) PCT Filed: Jul. 18, 2018
(86) PCT No.: PCT/JP2018/026823

§ 371 Date: Jan. 23, 2020

(30) Foreign Application Priority Data
Aug. 1, 2017 (JP) 2017-148856

(51) Int. Cl. G06F 3/01; G06F 3/16; G02B 27/00; G02B 27/01

(52) U.S. Cl. CPC G06F 3/016; G06F 3/012; G02B 2027/0178; G02B 27/0093; G02B 27/017; G06F 3/167

(57) ABSTRACT

The present disclosure relates to an information processing apparatus and an information processing method for performing processes on a target of interest corresponding to an operation input more accurately. Processing is performed on a target of interest on the basis of the target of interest and one of a first recognizer or a second recognizer, the target of interest being identified on the basis of status information regarding a user including at least either action information or position information regarding the user, the first recognizer being configured to recognize an operation input of the user, the second recognizer being configured to be different from the first recognizer and to recognize the operation input of the user. The present disclosure may be applied, for example, to information processing apparatuses, image processing apparatuses, control apparatuses, information processing systems, information processing methods, or information processing programs.

### TECHNICAL FIELD

The present disclosure relates to an information processing apparatus and an information processing method. More particularly, the disclosure relates to an information processing apparatus and an information processing method for performing processes on a target of interest more accurately corresponding to an operation input.

### BACKGROUND ART

Heretofore, there have been devices and systems which accept an operation input performed by a user such as by voice or gesture (action) and which perform processes on a target of the user's interest in a manner corresponding to the operation input (e.g., see PTL 1).

### CITATION LIST

### Patent Literature

### [PTL 1]

Japanese Patent Laid-open No. 2014-186361

### SUMMARY

### Technical Problem

However, it has not always been the case that given the operation input by the user, the target of the user's interest is processed exactly as intended by the user. Methods of performing processes on the target of interest corresponding to the operation input more accurately have therefore been sought after.

The present disclosure has been devised in view of the above circumstances. An object of the disclosure is to perform processes more accurately on a target of interest corresponding to an operation input.

### Solution to Problem

According to one aspect of the present technology, there is provided an information processing apparatus including a control section performing a process on a target of interest on the basis of the target of interest and one of a first recognizer or a second recognizer, the target of interest being identified on the basis of status information regarding a user including at least either action information or position information regarding the user, the first recognizer being configured to recognize an operation input of the user, the second recognizer being configured to be different from the first recognizer and to recognize the operation input of the user.

Also according to one aspect of the present technology, there is provided an information processing method including, by an information processing apparatus, performing a process on a target of interest on the basis of the target of interest and one of a first recognizer or a second recognizer, the target of interest being identified on the basis of status information regarding a user including at least either action information or position information regarding the user, the first recognizer being configured to recognize an operation input of the user, the second recognizer being configured to be different from the first recognizer and to recognize the operation input of the user.

Thus, according to one aspect of the present technology, there are provided an information processing apparatus and an information processing method by which a process is performed on a target of interest on the basis of the target of interest and one of a first recognizer or a second recognizer. The target of interest is identified on the basis of status information regarding a user including at least either action information or position information regarding the user. The first recognizer is configured to recognize an operation input of the user. The second recognizer is configured to be different from the first recognizer and to recognize the operation input of the user.

### Advantageous Effects of Invention

According to the present disclosure, it is possible to process information. More particularly, it is possible to perform processes on an object of interest more accurately corresponding to an operation input.

### BRIEF DESCRIPTION OF DRAWINGS

FIG. 1 is a view depicting examples of external appearances of an optical see-through HMD.

FIG. 2 is a block diagram depicting a principal configuration example of the optical see-through HMD.

FIG. 3 is a view explaining examples of how recognizers perform control corresponding to different operation targets.

FIG. 4 is a view explaining examples of how the recognizers perform control corresponding to different states.

FIG. 5 is a view explaining other examples of how the recognizers perform control corresponding to different states.

FIG. 6 is a view depicting examples of functions implemented by the optical see-through HMD.

FIG. 7 is a flowchart explaining an example of the flow of a control process.

FIG. 8 is a view explaining examples of gesture-related rules.

FIG. 9 is a view explaining another example of the gesture-related rules.

FIG. 10 is a view explaining other examples of the gesture-related rules.

FIG. 11 is a view explaining other examples of the gesture-related rules.

FIG. 12 is a view depicting examples of other functions implemented by the optical see-through HMD.

FIG. 13 is a flowchart explaining an example of the flow of another control process.

FIG. 14 is a flowchart explaining an example of the flow of a narrowing-down process.

### DESCRIPTION OF EMBODIMENTS

Some preferred embodiments for implementing the present disclosure (referred to as the embodiments) are described below. The description will be given under the following headings:

1. Execution of processes corresponding to the operation input
2. First embodiment (optical see-through HMD)
3. Second embodiment (utilization of rules of the operation input)
4. Other examples of application

### 5. Others

### <1. Execution of Processes Corresponding to the Operation Input>

Heretofore, there have been devices and systems which accept an operation input performed by a user such as by voice or gesture (action) and which perform processes on a target of the user's interest in a manner corresponding to the operation input. For example, the HMD (Head Mounted Display) described in PTL 1 recognizes and accepts gestures of the user relative to a virtual UI (User Interface) as an operation input. Such devices and systems detect information of images and sounds including the user's voice and gestures by use of a camera and a microphone, for example. On the basis of the detected information, these devices and systems recognize and accept the operation input of the user.

However, it has not always been the case that given the operation input by the user, the target of interest is processed exactly as intended by the user. Methods of processing the target of interest corresponding to the operation input more accurately have therefore been sought after.

What is proposed herein involves performing a process on a target of interest based on one of a first recognizer or a second recognizer, the first recognizer being configured to recognize the target of interest identified on the basis of status information regarding a user including at least either action information or position information regarding the user, the first recognizer being further configured to recognize an operation input of the user, the second recognizer being configured to be different from the first recognizer and to recognize the operation input of the user.

For example, there is provided an information processing apparatus including: a first recognizer configured to recognize a target of interest identified on the basis of status information regarding a user including at least either action information or position information regarding the user, the first recognizer being further configured to recognize an operation input of the user; a second recognizer configured to be different from the first recognizer and to recognize the operation input of the user; and a control section configured to perform a process on the target of interest on the basis of one of the first recognizer or the second recognizer.

The action information regarding the user refers to the information related to the user's actions. Here, the user's actions may include the operation input performed by the user having resource to visual line direction, focal point distance, degree of pupil dilation, ocular fundus pattern, and opening and closing of eyelids (the operation input may also be referred to as the visual line input hereunder). For example, the visual line input includes the user moving the direction of his or her visual line and fixing it in a desired direction. In another example, the visual line input includes the user varying his or her focal point distance and fixing it to a desired distance. In yet another example, the visual line input includes the user varying the degree of his or her pupil dilation (dilating and contracting the pupils). In a further example, the visual line input includes the user opening and closing his or her eyelids. In a yet further example, the visual line input includes the user inputting the user's identification information such as his or her ocular fundus pattern.

Also, the user's actions may include an operation input performed by the user moving his or her body (such physical motion or movement may be referred to as the gesture hereunder; and such operation input may be referred to as the gesture input hereunder). In another example, the user's actions may include an operation input based on the user's voice (referred to as the voice input hereunder). Obviously, the user's actions may include other actions than those mentioned above.

The gestures may include motions such as varying the orientation of the neck (head (face); referred to as the head-bobbing gesture or as the head gesture hereunder). In another example, the gestures may include moving the hand (shoulder, arm, palm, or fingers) or bringing it into a predetermined posture (referred to as the hand gesture hereunder). Obviously, the gestures may include motions or movements other than those mentioned above. The operation input performed by head gesture is also referred to as the head gesture input. Further, the operation input performed by hand gesture is also referred to as the hand gesture input.

The position information regarding the user means information regarding the position of the user. This position information may be given either as an absolute position in a predetermined coordinate system or as a relative position in reference to a predetermined object.

The status information regarding the user means user-related information including at least either the action information or the position information regarding the user. The target of interest means the target of the user's interest. As described above, the target of interest is identified on the basis of the status information regarding the user.

For example, the user performs an operation input as an instruction to execute a certain process on the target of interest. The control section mentioned above recognizes the operation input using a recognizer, identifies the process on the target of interest corresponding to the operation input (i.e., the process desired by the user), and performs the identified process. At this point, the control section performs the process on the target of interest on the basis of the target of interest and on one of the first and the second recognizers that are different from each other. Thus, the control section can perform the process more accurately on the target of interest corresponding to the operation input.

As described above, the first and the second recognizers are each configured to recognize the operation input of the user and are different from each other. The first and the second recognizers may each be configured with a single recognizer or with multiple recognizers. That is, the first and the second recognizers may each be configured to recognize either a single operation input type (e.g., hand gesture input alone or voice input alone) or multiple operation input types (e.g., hand gesture input and voice input, or head gesture input and visual line input).

If the recognizer or recognizers (recognizable operation input types) constituting the first recognizer are not completely identical to the recognizer or recognizers (recognizable operation input types) making up the second recognizer, then the first and the second recognizers may each have any desired configuration or configurations (recognizable operation input types). For example, the first recognizer may include a recognize not included in the second recognizer, and the second recognizer may include a recognizer not included in the first recognizer. This enables the control section to select one of the first recognizer or the second recognizer in order to accept (recognize) different types of operation input. That is, the control section can accept the appropriate type of operation input depending on the circumstances (e.g., the target of interest), thereby accepting the user's operation input more accurately. As a result, the control section can perform processes more accurately on the target of interest corresponding to the operation input.

Alternatively, the first recognizer may include a recognizer not included in the second recognizer. As another alternative, the second recognizer may include a recognizer not included in the first recognizer.

As a further alternative, the number of recognizers (number of recognizable operation input types) constituting the first recognizer need not be the same as the number of recognizers (number of recognizable operation input types) making up the second recognizer. For example, the first recognizer may include a single recognizer, and the second recognizer may include multiple recognizers.

### 2. First Embodiment

<Incorrect Recognition or Non-Recognition of the User's Operation Input>

For example, it is not always the case that the operation input of the user is correctly recognized by any method. There are easy and difficult methods of recognition depending on the circumstances. For this reason, if there are only difficult methods of recognition under the circumstances, there can be a case where the use's operation input is not recognized (missed, hence the fear of non-recognition). Conversely, if there are too many easy methods of recognition, there can be a case where the absence of the user's operation input is falsely recognized as an operation input (hence the fear of incorrect recognition).

<Control of the Recognizers Based on the Target of Operation>

In order to reduce the occurrence of the above-mentioned incorrect recognition or non-recognition, a first embodiment uses the more appropriate of the recognizers depending on the circumstances. For example, the above-mentioned control section activates one of the first recognizer or the second recognizer and deactivates the other recognizer on the basis of the identified target of interest so as to carry out processes on the target of interest in accordance with the activated recognizer.

In this manner, the recognizer to be used is selected more appropriately depending on the circumstances (target of interest). The control section is thus able to recognize the user's operation input more accurately. On the basis of the result of the recognition, the control section can perform processes on the target of interest more precisely.

<External Appearances of the Optical See-Through HMD>

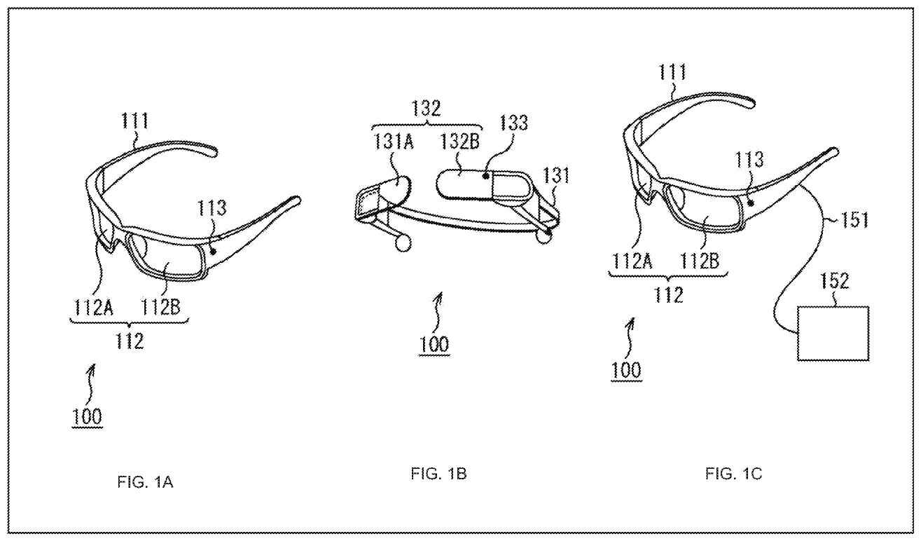

FIG. 1 depicts examples of external appearances of an optical see-through HMD as an information processing apparatus to which the present technology is applied. As illustrated in A in FIG. 1, a housing 111 of an optical see-through HMD 100 has a so-called eyeglass shape. As with eyeglasses, the housing 111 is attached to the user's face in such a manner that its end parts are hooked on the user's ears.

The parts corresponding to the lenses of eyeglasses constitute a display section 112 (including a right-eye display section 112A and a left-eye display section 112B). When the user wears the optical see-through HMD 100, the right-eye display section 112A is positioned near the front of the user's right eye and the left-eye display section 112B is positioned near the front of the user's left eye.

The display section 112 is a transmissive display that lets light pass through. That means the user's right eye can see the backside of the right-eye display section 112A, i.e., a real-world scene (see-through image) in front of the right-eye display section 112A as viewed therethrough. Likewise, the user's left eye can see the backside of the left-eye display section 112B, i.e., a real-world scene (see-through image) in front of the left-eye display section 112B as viewed therethrough. Therefore, the user sees the image displayed on the display section 112 in a manner superimposed in front of the real-world scene beyond the display section 112.

The right-eye display section 112A displays an image for the user's right eye to see (right-eye image), and the left-eye display section 112B displays an image for the user's left eye to see (left-eye image). That is, the display section 112 may display a different image on each of the right-eye display section 112A and the left-eye display section 112B. This makes it possible for the display section 112 to display a three-dimensional image, for example.

Further, as illustrated in FIG. 1, a hole 113 is formed near the display section 112 of the housing 111. Inside the housing 111 near the hole 113 is an imaging section for capturing a subject. Through the hole 113, the imaging section captures the subject in the real space in front of the optical see-through HMD 100 (the subject in the real space beyond the optical see-through HMD 100 as seen from the user wearing the optical see-through HMD 100). More specifically, the imaging section captures the subject in the real space positioned within a display region of the display section 112 (right-eye display section 112A and left-eye display section 112B) as viewed from the user. Capturing the subject generates image data of the captured image. The generated image data is stored on a predetermined storage medium or transmitted to another device, for example.

Incidentally, the hole 113 (i.e., the imaging section) may be positioned where desired. The hole 113 may be formed in a position other than that depicted in A in FIG. 1. Also, a desired number of holes 113 (i.e., imaging sections) may be provided. There may be a single hole 113 as in A in FIG. 1, or there may be multiple holes 113.

Further, the housing 111 may be shaped as desired as long as the housing 111 can be attached to the user's face (head) in such a manner that the right-eye display section 112A is positioned near the front of the user's right eye and the left-eye display section 112B is positioned near the front of the user's left eye. For example, the optical see-through HMD 100 may be shaped as illustrated in B in FIG. 1.

In the case of the example in B in FIG. 1, a housing 131 of the optical see-through HMD 100 is shaped in a manner pinching the user's head from behind when in a fixed position. A display section 132 in this case is also a transmissive display as with the display section 112. That is, the display section 132 also has a right-eye display section 132A and a left-eye display section 132B. When the user wears the optical see-through HMD 100, the right-eye display section 132A is positioned near the front of the user's right eye and the left-eye display section 132B is positioned near the front of the user's left eye.

The right-eye display section 132A is a display section similar to the right-eye display section 112A. The left-eye display section 132B is a display section similar to the left-eye display section 112B. That is, as with the display section 112, the display section 132 can also display a three-dimensional image.

In the case of B in FIG. 1, as in the case of A in FIG. 1, a hole 133 similar to the hole 113 is provided near the display section 132 of the housing 131. Inside the housing 131 near the hole 133 is an imaging section for capturing a subject. As in the case of A in FIG. 1, through the hole 133, the imaging section captures the subject in the real space in front of the optical see-through HMD 100 (the subject in the real space beyond the optical see-through HMD 100 as seen from the user wearing the optical see-through HMD 100).

Obviously, as in the case of A in FIG. 1, the hole 133 (i.e., imaging section) may be positioned where desired. The hole 133 may be formed in a position other than that depicted in B in FIG. 1. Also, a desired number of holes 133 (i.e., imaging sections) may be provided as in the case of A in FIG. 1.

Further, as in an example depicted in C in FIG. 1, a portion of the optical see-through HMD 100 configured as illustrated in A in FIG. 1 may be configured separately from the housing 111. In the case of the example in C in FIG. 1, the housing 111 is connected with a control box 152 via a cable 151.

The cable 151, which is a communication channel for predetermined wired communication, electrically connects the circuits in the housing 111 with the circuits in the control box 152. The control box 152 includes a portion of the internal configuration (circuits) of the housing 111 in the case of the example in A in FIG. 1. For example, the control box 152 has a control section and a storage section for storing image data. With communication established between the circuits in the housing 111 and those in the control box 152, the imaging section in the housing 111 may capture an image under control of the control section in the control box 152, before supplying image data of the captured image to the control box 152 for storage into its storage section.

The control box 152 may be placed in a pocket of the user's clothes, for example. In such a configuration, the housing 111 of the optical see-through HMD 100 may be formed to be smaller than in the case of A in FIG. 1.

Incidentally, the communication between the circuits in the housing 111 and those in the control box 152 may be implemented in wired or wireless fashion. In the case of wireless communication, the cable 151 may be omitted.

<Example of the Internal Configuration>

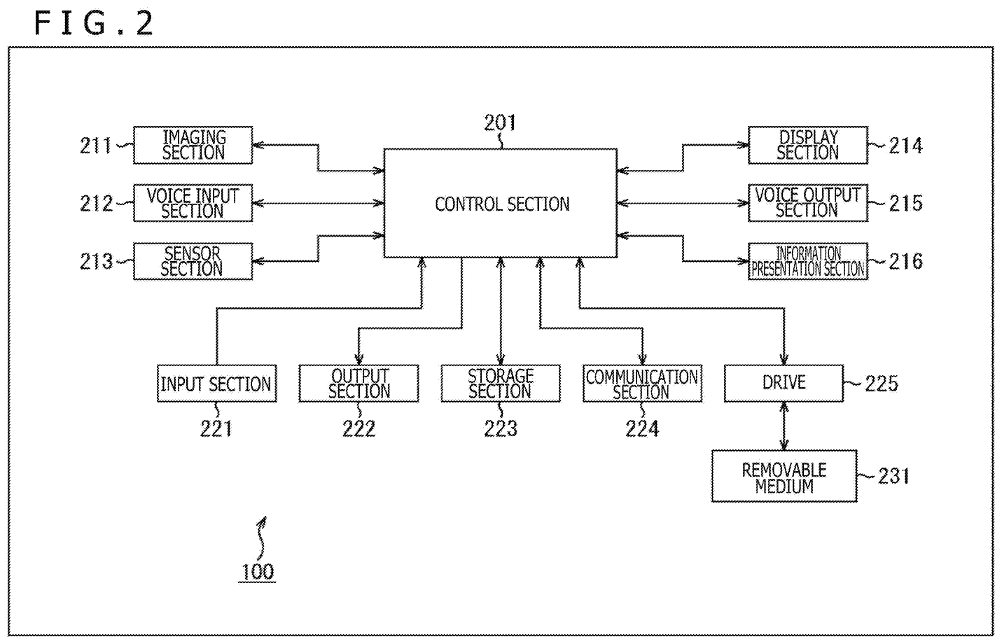

FIG. 2 is a block diagram depicting an example of the internal configuration of the optical see-through HMD 100. As illustrated in FIG. 2, the optical see-through HMD 100 has a control section 201.

The control section 201 is configured using a microcomputer that includes a CPU (Central Processing Unit), a ROM (Read Only Memory), a RAM (Random Access Memory), a nonvolatile memory section, and an interface section, for example. The control section 201 performs desired processes by executing programs. For example, the control section 201 performs processes based on the recognition of the user's operation input and on the result of the recognition. Further, the control section 201 controls the components of the optical see-through HMD 100. For example, the control section 201 may drive the components in a manner corresponding to the performed processes such as detecting information regarding the user's action and outputting the result of the process reflecting the user's operation input.

The optical see-through HMD 100 also includes an imaging section 211, a voice input section 212, a sensor section 213, a display section 214, a voice output section 215, and an information presentation section 216.

The imaging section 211 includes an optical system configured with an imaging lens, a diaphragm, a zoom lens, and a focus lens; a driving system that causes the optical system to perform focus and zoom operations; and a solid-state imaging element that generates an imaging signal by detecting imaging light obtained by the optical system and by subjecting the detected light to photoelectric conversion. The solid-state imaging element is configured as a CCD (Charge Coupled Device) image sensor or a CMOS (Complementary Metal Oxide Semiconductor) image sensor, for example.

The imaging section 211 may have a desired number of optical systems, a desired number of driving systems, and a desired number of solid-state imaging elements. Each of these components may be provided singly or in multiple numbers. Each optical system, each driving system, and each solid-state imaging element in the imaging section 211 may be positioned where desired in the housing of the optical see-through HMD 100, or may be provided independent of the housing of the optical see-through HMD 100 (as a separate unit or units). There may be a single or multiple directions (field angles) in which the imaging section 211 captures images.

Under control of the control section 201, the imaging section 211 focuses on a subject, captures the subject, and supplies data of the captured image to the control section 201.

The imaging section 211 captures the scene in front of the user (real-world subject in front of the user) through the hole 113, for example. Naturally, the imaging section 211 may capture the scene in some other direction such as behind the user. Using such a captured image, the control section 201 may grasp (recognize) the surroundings (environment), for example. The imaging section 211 may supply the captured image as the position information regarding the user to the control section 201, so that the control section 201 can grasp the position of the user on the basis of the captured image. In another example, the imaging section 211 may supply the captured image as the action information regarding the user to the control section 201, so that the control section 201 may grasp (recognize) the head gesture (e.g., direction in which the user faces, visual line direction of the user, or what the head-bobbing gesture looks like) of the user wearing the optical see-through HMD 100.

Further, the imaging section 211 may capture the head (or face) of the user wearing the optical see-through HMD 100. For example, the imaging section 211 may supply such a captured image as the action information regarding the user to the control section 201, so that the control section 201 can grasp (recognize) the head gesture of the user on the basis of the captured image.

Furthermore, the imaging section 211 may capture the eyes (eyeball potions) of the user wearing the optical see-through HMD 100. For example, the imaging section 211 may supply such a captured image as the action information regarding the user to the control section 201, so that the control section 201 can grasp (recognize) the user's visual line input on the basis of the captured image.

Moreover, the imaging section 211 may capture the hand (shoulder, arm, palm, or fingers) of the user wearing the optical see-through HMD 100. For example, the imaging section 211 may supply such a captured image as the action information regarding the user to the control section 201, so that the control section 201 can grasp (recognize) the user's hand gesture input on the basis of the captured image.

Incidentally, the light detected by the solid-state imaging element of the imaging section 211 may be in any wavelength band and is not limited to visible light. The solid-state imaging element may capture visible light and have the captured image displayed on the display section 214, for example.

The voice input section 212 includes a voice input device such as a microphone. The voice input section 212 may include a desired number of voice input devices. There may be a single or multiple voice input devices. Each voice input device of the voice input section 212 may be positioned where desired in the housing of the optical see-through HMD 100. Alternatively, each voice input device may be provided independent of the housing of the optical see-through HMD 100 (as a separate unit).

The voice input section 212, under control of the control section 201, for example, collects sounds from the surroundings of the optical see-through HMD 100 and performs signal processing such as A/D conversion on the collected sounds. For example, the voice input section 212 collects the voice of the user wearing the optical see-through HMD 100, performs signal processing on the collected voice to obtain a voice signal (digital data), and supplies the voice signal as the action information regarding the user to the control section 201. The control section 201 may then grasp (recognize) the user's voice input on the basis of that voice signal.

The sensor section 213 includes such sensors as an acceleration sensor, a gyro sensor, a magnetic sensor, and an atmospheric pressure sensor. The sensor section 213 may have any number of sensors of any type. There may be a single or multiple sensors. Each of the sensors of the sensor section 213 may be positioned where desired in the housing of the optical see-through HMD 100. Alternatively, the sensors may be provided independent of the housing of the optical see-through HMD 100 (as a separate unit or units).

The sensor section 213, under control of the control section 201, for example, drives the sensors to detect information regarding the optical see-through HMD 100 as well as information regarding the surroundings thereof. For example, the sensor section 213 may detect an operation input such as visual line input, gesture input, or voice input performed by the user wearing the optical see-through HMD 100. The information detected by the sensor section 213 may be supplied as the action information regarding the user to the control section 201. In turn, the control section 201 may grasp (recognize) the user's operation input on the basis of the supplied information. The information detected by the sensor section 213 and supplied, for example, as the action information regarding the user to the control section 201 may be used by the latter as the basis for grasping the position of the user, for example.

The display section 214 includes the display section 112 as a transmissive display, an image processing section that performs image processing on the image displayed on the display section 112, and control circuits of the display section 112. The display section 214, under control of the control section 201, for example, causes the display section 112 to display the image corresponding to the data supplied from the control section 201. This allows the user to view the information presented as the image.

The image displayed on the display section 112 is viewed by the user as superimposed in front of the real-space scene. For example, the display section 214 enables the user to view the information corresponding to an object in the real space in a manner superimposed on that object in the real space.

The voice output section 215 includes a voice output device such as speakers or headphones. The voice output device of the voice output section 215 is provided in the housing of the optical see-through HMD 100 and positioned near the ears of the user wearing the optical see-through HMD 100. The voice output section 215 outputs sounds toward the user's ears.

The voice output section 215, under control of the control section 201, for example, causes the voice output device to output the sound corresponding to the data supplied from the control section 201. This allows the user wearing the optical see-through HMD 100 to hear voice guidance regarding an object in the real space, for example.

The information presentation section 216 includes a suitable output device such as an LED (Light Emitting Diode) or an oscillator. The information presentation section 216 may have any number of output devices of any type. There may be a single or multiple output devices. Each of the sensors of the information presentation section 216 may be positioned where desired in the housing of the optical see-through HMD 100. Alternatively, the sensors may be provided independent of the housing of the optical see-through HMD 100 (as a separate unit or units).

The information presentation section 216, under control of the control section 201, for example, presents the user with appropriate information in an appropriate manner. For example, the information presentation section 216 may present the user with desired information by causing the LED to emit light or to flash using predetermined light-emitting patterns. In another example, the information presentation section 216 may notify the user of desired information by causing the oscillator to vibrate the housing of the optical see-through HMD 100. This allows the user to obtain information in a manner other than by use of images or sounds. That is, the optical see-through HMD 100 can supply the user with information in more diverse ways than before.

The optical see-through HMD 100 further includes an input section 221, an output section 222, a storage section 223, a communication section 224, and a drive 225.

The input section 221 includes operation buttons, a touch panel, an input terminal, and the like. The input section 221, under control of the control section 201, for example, accepts information supplied from the outside and feeds the accepted information to the control section 201. For example, the input section 221 accepts an operation input of the user performed on the operation buttons or on the touch panel. In another example, the input section 221 accepts information (e.g., data such as images or sounds as well as control information) supplied from another apparatus via the input terminal.

The output section 222 includes an output terminal, for example. The output section 222, under control of the control section 201, for example, supplies another apparatus with data fed from the control section 201 via the output terminal.

The storage section 223 includes a suitable storage device such as an HDD (Hard Disk Drive), a RAM disk, or a nonvolatile memory. The storage section 223, under control of the control section 201, for example, causes the storage device to store and manage in its storage areas the data or programs supplied from the control section 201. Also, under control of the control section 201, the storage section 223 may cause the storage device to retrieve from its storage areas the data or programs requested by the control section 201 and supply the retrieved data or programs to the control section 201.

The communication section 224 is configured using a communication device that transmits and receives information such as programs or data to and from an external apparatus via a predetermined communication medium (e.g., suitable networks such as the Internet). Alternatively, the communication section 224 may be configured using a network interface. The communication section 224, under control of the control section 201, for example, communicates with (transmits and receives programs or data to and from) an apparatus external to the optical see-through HMD 100. In so doing, the communication section 224 transmits the data or programs supplied from the control section 201 to the external apparatus acting as the communication partner. The communication section 224 further receives the data or programs supplied from the external apparatus and sends what is received to the control section 201. The communication section 224 may have either one of or both a wired communication function and a wireless communication function.

The drive 225 reads information (programs or data) from a removable medium 231 such as a magnetic disk, an optical disk, a magneto-optical disk, or a semiconductor memory loaded into the drive 225. The drive 225 supplies the control section 201 with the information read from the removable medium 231. When loaded with writable removable medium 231, the drive 225 may write the information (programs or data) supplied from the control section 201 onto the removable medium 231.

The control section 201 performs diverse processes by loading and executing programs from the storage section 223, for example.

<Examples of Control of the Recognizers Based on the Operation Target>

As described above, the optical see-through HMD 100 performs a process on a target of interest on the basis of the target of interest identified by status information regarding a user including at least either action information or position information regarding the user, and in accordance with either a first recognizer configured to recognize an operation input of the user or a second recognizer configured to be different from the first recognizer and to recognize the operation input of the user.

In that case, the control section 201 may activate one of the first recognizer or the second recognizer and deactivate the other recognizer on the basis of the identified target of interest so as to perform the process on the target of interest on the basis of the activated recognizer.

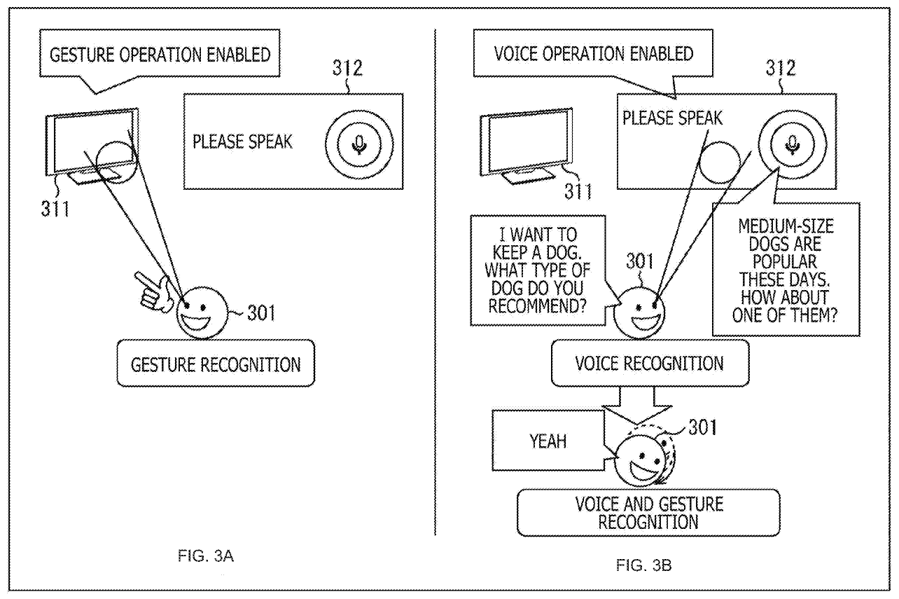

For example, as depicted in FIG. 3, it is assumed that a user 301 sees through the display section 112 a television apparatus 311 in the real space and that the user 301 sees a GUI (Graphical User Interface) 312 for voice input on the display section 112. That is, the television apparatus 311 is an object in the real space, whereas the GUI 312 is an object in a virtual space displayed on the display section 112. The user 301 is assumed to perform operations such as power on/off, channel selection, sound volume adjustment, and image quality adjustment on the television apparatus 311 using the hand gesture input via the optical see-through HMD 100. The user 301 is further assumed to input desired requests and instructions to the GUI 312 using the voice input. The imaging section 211 or the sensor section 213 in the optical see-through HMD 100 is assumed to detect the visual line input (operation input based on the visual line direction). The control section 201 is assumed to recognize the detected operation input and be ready to accept selection of the operation target by the visual line of the user 301.

Here, suppose that the user 301 sets his or her visual line to the television apparatus 311 as depicted in A in FIG. 3. In this case, the control section 201, which recognizes the visual line input, recognizes that the user 301 has selected the television apparatus 311 as the target of interest (operation target). The control section 201 then turns on the recognizer that recognizes the hand gesture input (activates the recognizer that recognizes the hand gesture input). That is, the operation input of the user 301 in this case includes the user's hand gesture input. Further, the activated recognizer includes a recognizer configured to recognize the hand gesture input. In a case where the target of interest to be identified is operable by voice, the control section 201 performs a process on the target of interest on the basis of the hand gesture input recognized by the activated recognizer.

Further, when the user 301 sets his or her visual line to the GUI 312 as depicted in B in FIG. 3, for example, the control section 201, which recognizes the visual line input, recognizes that the user 301 has selected the GUI 312 as the operation target. Thus, the control section 201 turns on the recognizer that recognizes the voice input (activates the recognizer for recognizing the voice input). That is, the operation input of the user 301 in this case includes the user 301's voice input. Further, the activated recognizer includes a recognizer configured to recognize the voice input. Also, in a case where the target of interest to be identified is operable by voice, the control section 201 performs a process on the target of interest on the basis of the voice input recognized by the activated recognizer.

In the case of the above example, the status information (action information) regarding the user 301 includes selection of the target of interest (operation target) by the visual line input of the user 301. The target of interest is the television apparatus 311 as well as the GUI 312. The first recognizer includes, for example, the recognizer that recognizes the hand gesture input. The second recognizer includes, for example, the recognizer that recognizes the voice input. In the case where the target of interest is the television apparatus 311, for example, the process on the target of interest is power on/off, channel selection, sound volume adjustment, or image quality adjustment. In the case where the target of interest is the GUI 312, for example, the process on the target of interest is a desired request or instruction.

The above-described operation input on the television apparatus 311 is difficult to achieve using the visual line input. For example, during an attempt to designate an operation by the visual line input, letting the visual line stray from the television apparatus 311 can deflect the target of interest (operation target) from the television apparatus 311. Conceivably, the target of interest might be fixed to the television apparatus 311 to subsequently permit operations thereon by the visual line input. This, however, raises fear that it may take a long time to fix the target of interest to the television apparatus 311 or that cumbersome work may be involved. The visual line direction is relatively difficult to recognize with high accuracy in the first place, so that the visual line input is not very suitable for fine controls such as sound volume adjustment or channel selection on the television apparatus 311.

Thus, in the case of A in FIG. 3, the recognizer for recognizing the hand gesture input of the user 301 is turned on as described above. The hand gesture input is an operation input method suitable for the television apparatus 311. This method enables the optical see-through HMD 100 to recognize the operation input more accurately. That is, with the television apparatus 311 made operable with hand gesture, the user 301 can operate the television apparatus 311 more accurately (more easily).

At this point, the recognizer for recognizing the voice input deemed unsuitable for the operation input on the television apparatus 311 may be turned off (the recognizer for recognizing the voice input may be deactivated). This enables the control section 201 to suppress the occurrence of incorrect recognition of the operation input.

Further, the above-mentioned operation input on the GUI 312 is difficult to achieve using the visual line input. Thus, in the case of B in FIG. 3, the recognizer that recognizes the voice input of the user 301 is turned on as discussed above. The voice input is an operation input method suitable for the GUI 312. This method enables the optical see-through HMD 100 to recognize the operation input more accurately. That is, with the GUI 312 made operable by voice, the user 301 can operate the GUI 312 more accurately (more easily).

At this point, the operation input of the user 301 may include the hand gesture input of the user 301, and the deactivated recognizer may include a recognizer configured to recognize the hand gesture input. For example, the recognizer for recognizing the hand gesture input not suitable as the operation input on the GUI 312 may be turned off (the recognizer for recognizing the hand gesture input may be deactivated). This enables the control section 201 to suppress the occurrence of incorrect recognition of the operation input.

Also, in the case of B in FIG. 3, it may be preferable not only to turn on the recognizer for recognizing the voice input of the user 301 but also to activate the recognizer for recognizing the head gesture (e.g., head-bobbing gesture) input of the user 301.

For example, suppose that the user 301 asks the GUI 312 a question like “I want to keep a dog. What type of dog do you recommend?” and that the GUI 312 answers by returning a question like “Medium-size dogs are popular these days. How about one of them?” The user 301 is then expected to give an answer. What is most expected here as the answer is a relatively short voice input including only an answer particle such as “Yeah,” “Yes,” “Nope,” or “No.” This answer particle corresponds to a “response word” or an “affirmative/negative reply.” Such a short voice input can result in a reduced success rate of recognition. In the case of the above-mentioned answer particle, the user 301 often moves the neck (head) repeatedly in a vertical or horizontal direction in a head-bobbing gesture simultaneously with the utterance.

Thus, it is assumed here that the operation input of the user 301 includes his or her head gesture input, that the activated recognizer includes a recognizer configured to recognize the head gesture input, and that the target of interest to be identified can be operated using the voice input. In that case, using the activated recognizers to recognize both the head gesture input and the voice input, the control section 201 performs a process regarding the target of interest on the basis of either the head gesture input or the voice input being recognized.

More specifically, in the case of B in FIG. 3, the user performs the head gesture such as a nod simultaneously with the utterance of the answer particle such as “Yeah.” The control section 201 in turn recognizes these operation inputs using the respectively activated recognizers, and proceeds with the next process on the basis of the result of recognition by one of the recognizers.

In this manner, the optical see-through HMD 100 recognizes the predetermined operation input such as operation inputs indicative of an affirmation or a negation using not only voice input but also head-bobbing gesture. As a result, the optical see-through HMD 100 can recognize the operation input more accurately.

It is to be noted that the recognizer for recognizing the hand gesture and the recognizer for recognizing the voice, if left turned on from the start, can detect the user's unnecessary actions (operations or voices other than those intended as an operation instruction) and incorrectly recognize the detected action as an operation input. The occurrence of such incorrect recognition is suppressed by having these recognizers activated selectively depending on the operation target. In other words, the optical see-through HMD 100 is enabled to recognize the operation input more accurately.

When the recognizer to be used is controlled (selected) on the basis of the operation target identified in accordance with the user's action as described above, the appropriate recognizer is used for a given operation target. This enables the optical see-through HMD 100 in diverse circumstances to recognize the operation input more accurately.

Incidentally, the user may perform any action desired. The user's action is not limited to the above-described visual line input. The action may be the user's approach to the operation input, the user's voice input, or a combination of multiple such actions, for example. In another example, the user's actions may include at least one of such actions as the user's visual line input, the user's approach to the operation target, or the user's voice input.

Further, the operation target to be identified on the basis of the user's action may occur singly or in multiple numbers. The operation target to be identified on the basis of the user's action may be an object either in the real space or in a virtual space. In the above example, the object in the real space is the television apparatus 311 and the object in the virtual space is the GUI 312. That is, the operation target may be either existent or non-existent (the target need not be a tangible object).

Further, there may be any number of the first and the second recognizers. The first and the second recognizers may each be provided singly or in multiple numbers. It is sufficient if at least one of the first recognizer or the second recognizer includes a recognizer that is not included in the other recognizer. For example, the first and the second recognizers may include at least one of a recognizer for recognizing the user's voice, a recognizer for recognizing the user's visual line, a recognizer for recognizing the user's hand gesture, or a recognizer for recognizing the user's head-bobbing gesture.

Furthermore, in a case where a first operation target and a second operation target are recognized, the first operation target may be controlled on the basis of the first recognizer and the second operation target may be controlled in accordance with the second recognizer. That is, with multiple operation targets recognized, the operation input on these operation targets may be detected using mutually different recognizers (that do not fully coincide with one another). In the case of FIG. 3, for example, the optical see-through HMD 100 may recognize both the television apparatus 311 and the GUI 312 as the operation targets and accept the operation input on the television apparatus 311 using the recognizer for recognizing the user's hand gesture and the operation input on the GUI 312 using the recognizer for recognizing the user's voice. In this manner, the optical see-through HMD 100 can recognize the operation input on each of the operation targets more accurately.

<First Example of Controlling the Recognizers in Accordance with the State>

Further, the process on the operation target may be carried out in accordance with the user's operation input recognized by the recognizer corresponding to the current state (operation input state) set on the basis of the user's action. That is, the state regarding the operation is managed and updated as needed in accordance with the user's action (e.g., operation input). The recognizer to be used is then selected in accordance with the current state. This enables the user to perform the operation input using the (more appropriate) recognizer corresponding to the state regarding the operation. That means the user is able to operate the operation target more accurately (more easily). That is, the optical see-through HMD 100 in more diverse circumstances can recognize the operation input more accurately.

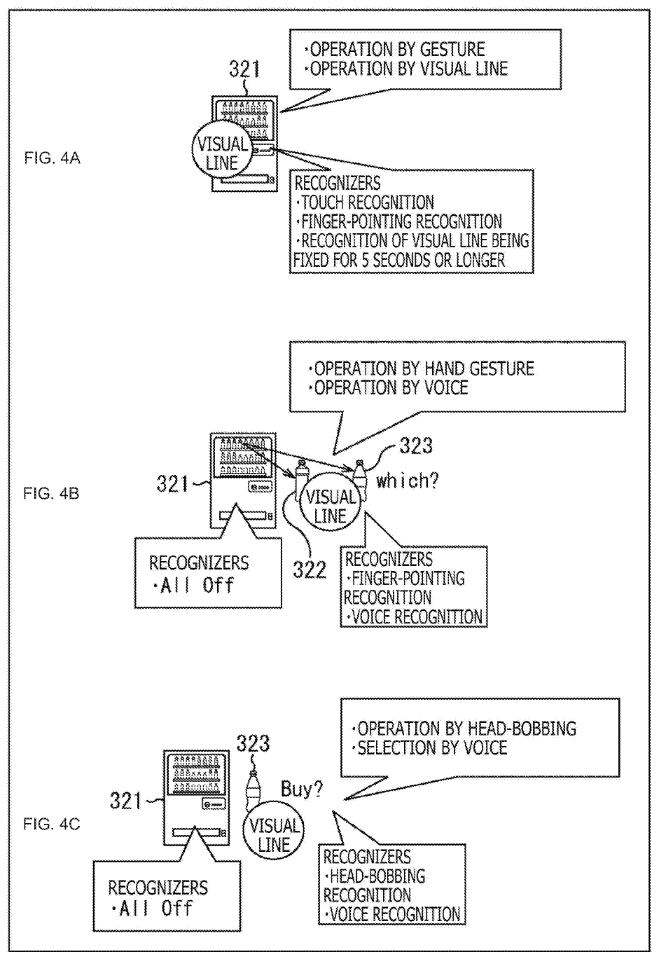

Explained below is an example in which a bottle of drinking water is bought by operating an automatic water vending machine as illustrated in FIG. 4. First, the optical see-through HMD 100 sets the state for selection of the operation target as depicted in A in FIG. 4. For this purpose, the optical see-through HMD 100 turns on the recognizer for recognizing the hand gesture and the recognizer for recognizing the visual line to permit selection by hand gesture and selection by visual line.

For example, an automatic vending machine 321 can be selected as the operation target using a touch operation or a finger-pointing operation performed by the user on the automatic vending machine 321. In another example, the automatic vending machine 321 can be selected as the operation target by the user gazing at (fixing his or her visual line to) the automatic vending machine 321 for at least five seconds (for a predetermined time period or longer). The automatic vending machine 321 may be an object in the real space (a real, existent object) or an object in a virtual space (non-existent object) displayed on the display section 112.

For example, when the user sets his or her visual line to the automatic vending machine 321 for five seconds or longer, the optical see-through HMD 100 selects the automatic vending machine 321 as the operation target and updates the state to one for selecting a drinking water bottle as depicted in B in FIG. 4. For this purpose, the optical see-through HMD 100 first turns off all above-described recognizers for selecting the above-mentioned automatic vending machine 321.

The optical see-through HMD 100 then causes the display section 112 to display magnified images of selectable drinking water bottles (images 322 and 323 in the example of B in FIG. 4). The optical see-through HMD 100 further turns on the recognizer for recognizing the hand gesture and the recognizer for recognizing the voice, thus permitting selection by hand gesture and selection by voice. For example, the (image of) desired drinking water bottle is selected as the operation target by the user pointing a finger at the image 322 or 323 or voicing a product name or a directive.

As described above, in the case of the state for letting the user select a desired object from multiple objects, the recognizer for recognizing the user's voice and the recognizer for recognizing the user's hand gesture may be used. By recognizing not only the voice but also the hand gesture, the optical see-through HMD 100 is able to recognize the operation input regarding the selection more accurately.

In the above state for selection, only the recognizer for recognizing the user's voice may be turned on first and, when the directive is recognized, the recognizer for recognizing the user's hand gesture may be turned on to accept the operation input by hand gesture. Generally, the success rate of recognizing a short voice such as the directive (this one, that one, there, which one) is low. With this taken into consideration, the operation input by hand gesture may be accepted only in the case of the directive alone being uttered. In such a case, the recognizer for recognizing the hand gesture may remain off (kept turned off) if voice recognition turns out to be sufficiently accurate such as when the user utters a product name.

For example, when the user points a finger at the image 323, the optical see-through HMD 100 selects the image 323 as the operation target and updates the state to one for confirming the purchase of the drinking water bottle as depicted in C in FIG. 4. For this purpose, the optical see-through HMD 100 first stops displaying the magnified image of the unselected drinking water bottle (image 322 in the example of C in FIG. 4) and turns off all recognizers for selecting drinking water bottles.

Then the display section 112 is caused to display the magnified image of the selected drinking water bottle (image 323 in the example of C in FIG. 4). The recognizer for recognizing the head-bobbing gesture and the recognizer for recognizing the voice are further turned on to permit selection by head-bobbing gesture and selection by voice. For example, the purchase of the desired drinking water bottle can be determined by the user moving the head vertically (an operation indicative of the intent to approve the purchase) or by the user uttering a voice such as “Yes” (a voice indicative of the intent to approve the purchase).

Thus, in the case of the state for letting the user select either approval or disapproval, the recognizer for recognizing the user's voice and the recognizer for recognizing the user's head-bobbing gesture may be used. As described above, the shorter the voice, the lower the success rate of recognizing it in general. For example, the voice such as “Yes” and “No” tends to be adopted as the user's voice in the state for letting the user select approval or disapproval. However, the success rate of recognizing the short voice such as “Yes” or “No” is relatively low.

Thus, in order to improve the success rate of recognizing the short voice, it may be preferred to recognize not only the voice but also the head gesture (e.g., head-bobbing gesture). For example, when expressing the intent to approve, the user performs the head-bobbing gesture of moving his or her head vertically while uttering the voice “Yes” simultaneously. In another example, when expressing the intent to disapprove, the user performs the head-bobbing gesture of moving his or her head horizontally while uttering the voice “No” at the same time. By recognizing both the voice and the head-bobbing gesture, the optical see-through HMD 100 can recognize the operation input to indicate the intent to approve or disapprove more accurately.

Of a first process corresponding to the head gesture input and a second process corresponding to the voice input, the first process may be executed preferentially by the control section 201. In a case where the activated recognizer recognizes the head gesture input, the control section 201 may perform the process on the basis of the head gesture input. In a case where the activated recognizer fails to recognize the head gesture input, the control section 201 may carry out the process on the basis of the voice input recognized by the activated recognizer. For example, in a case where the head-bobbing of the user is recognized, the process may be performed on the basis of the user's head-bobbing; in a case where the user's head-bobbing is not recognized, the process may be carried out in accordance with the user's voice. That is, if there occurs an inconsistency between the user's instruction by head-bobbing and the user's instruction by voice, the instruction by the user's head-bobbing may be preferentially processed. Generally, where the operation input by voice and the operation input by gesture are different from each other, the success rate of recognizing the short voice is relatively low as mentioned above. That means the voice is more likely to be false. Thus, when the recognition of the gesture is given precedence over the recognition of the voice, the operation input is recognized more accurately.

Further, when the recognizer to be used is turned on and any other recognizer not to be used is turned off depending on the state as explained above, the optical see-through HMD 100 can recognize the user's operation input using only the recognizer that is more appropriate for the current state than any other recognizer. This suppresses the occurrence of incorrect recognition or non-recognition of the operation input and contributes to more accurate recognition of the operation input. Moreover, the practice of not using unnecessary recognizers helps reduce the increase in processing load and the rise in power consumption.

<Second Example of Controlling the Recognizers in Accordance with the State>

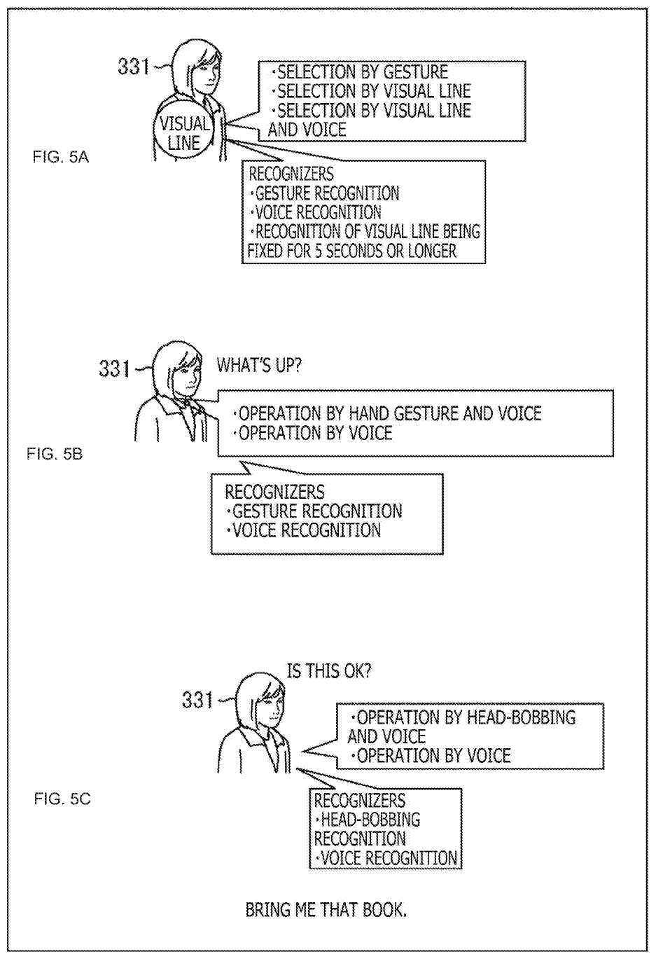

Explained below is an example in which a virtual agent is operated interactively as depicted in FIG. 5. The optical see-through HMD 100 first sets the state for selection of the operation target as illustrated in A in FIG. 5. For this purpose, the optical see-through HMD 100 turns on the recognizer for recognizing the hand gesture, the recognizer for recognizing the visual line, and the recognizer for recognizing the voice to permit selection by hand gesture, selection by visual line, and selection by visual line and voice.

For example, the user may select an agent 331, which is an object in a virtual space, with the hand gesture (e.g., finger-pointing) as the operation target. In another example, the user may select the agent 331 as the operation target by gazing at it (by setting the visual line to the agent 331) for at least five seconds (for a predetermined time period or longer). In a further example, the user may select the agent 331 as the operation target by uttering a voice for agent selection while gazing at the agent 331 (while setting the visual line thereto) simultaneously.

For example, when the user sets his or her visual lint to the agent 331 for at least five seconds, the optical see-through HMD 100 selects the agent 331 as the operation target and updates the state to one for inputting instructions to the agent 331 as depicted in B in FIG. 5.

The optical see-through HMD 100 outputs an image and a voice with which the agent 331 responds. In the example of B in FIG. 5, the agent 331 answers “What's up?” following its selection by the user as the operation target. The optical see-through HMD 100 further turns on the recognizer for recognizing the hand gesture and the recognizer for recognizing the voice so as to enable an operation by hand gesture and voice and an operation by voice.

For example, the user, while making a hand gesture (e.g., finger-pointing) to select the object, may utter a voice indicative of an instruction related to the object and input the instruction directed to the agent 331. In another example, the user may utter a voice (a directive) indicative of an instruction and input the instruction directed to the agent 331.

For example, suppose that the user, while pointing a finger at the image of a book as an object in a virtual space, utters “Bring me that book” as depicted in C in FIG. 5. In this case, the optical see-through HMD 100 recognizes the hand gesture and the voice and thereby recognizes an instruction directed to the agent 331. The optical see-through HMD 100 updates the state to one for confirmation of the instruction as illustrated in C in FIG. 5.

The optical see-through HMD 100 outputs an image and a voice with which the agent 331 responds. In the example of C in FIG. 5, the agent 331, given the instruction input from the user, answers “Is this OK?” while pointing a finger at the book selected by the user. The optical see-through HMD 100 further turns on the recognizer for recognizing the head-bobbing gesture and the recognizer for recognizing the voice so as to enable an operation by head-bobbing gesture and voice and an operation by voice. As in the case of the confirmation of purchase in C in FIG. 4, the optical see-through HMD 100 accepts the user's indication of the intent for approval or disapproval.

As explained above, the optical see-through HMD 100 turns on the recognizer to be used and turns off the recognizer not to be used, so that only the recognizer more appropriate for the current state than any other recognizer may be used to recognize the user's operation input. This suppresses the occurrence of incorrect recognition or non-recognition of the operation input for more accurate recognition thereof. That in turn suppresses the omission or false recognition of minute interactions that have been difficult to recognize. This makes it possible to implement more natural interactions.

<Functions>

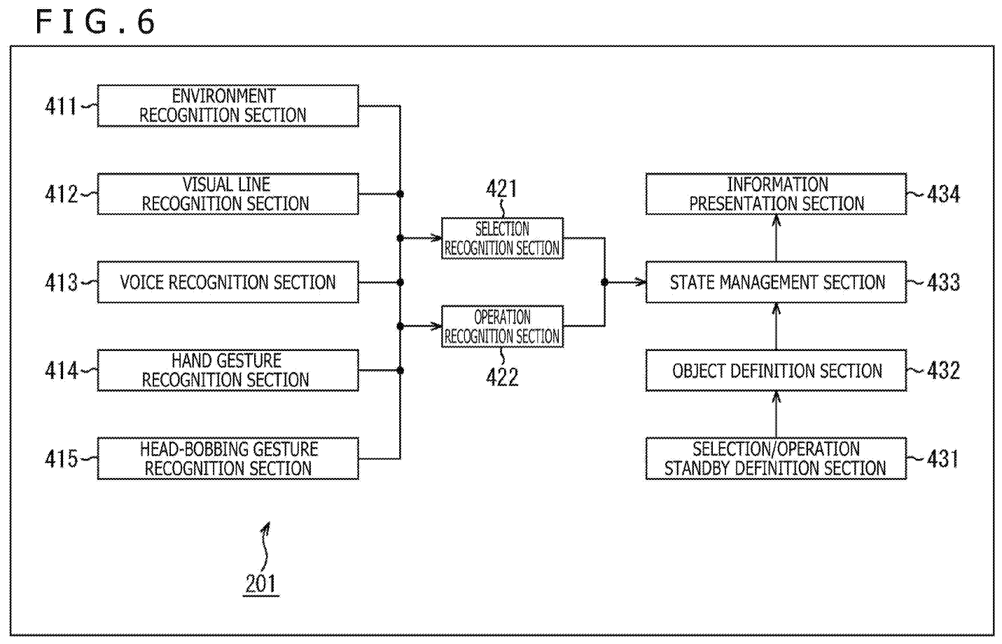

FIG. 6 is a functional block diagram indicating examples of major functions for carrying out the above-described processing. The control section 201 implements the functions depicted as the functional blocks in FIG. 6 by executing programs.

As illustrated in FIG. 6, through execution of programs, the control section 201 provides the functions of an environment recognition section 411, a visual line recognition section 412, a voice recognition section 413, a hand gesture recognition section 414, a head-bobbing gesture recognition section 415, a selection recognition section 421, an operation recognition section 422, a selection/operation standby definition section 431, an object definition section 432, a state management section 433, and an information presentation section 434, for example.

The environment recognition section 411 performs processes related to recognition of the environment (surroundings of the optical see-through HMD 100). For example, the environment recognition section 411 recognizes operation targets around the optical see-through HMD 100 on the basis of images of the surroundings of the optical see-through HMD 100, the images being captured by an environment recognition camera of the imaging section 211. The environment recognition section 411 supplies the result of the recognition to the selection recognition section 421 and to the operation recognition section 422.

The visual line recognition section 412 performs processes related to recognition of the user's visual line. For example, the visual line recognition section 412 recognizes the user's visual line (visual line direction and the operation target indicated by the visual line) on the basis of an image of the eyes of the user wearing the optical see-through HMD 100, the image being captured by a visual line detection camera of the imaging section 211. The visual line recognition section 412 supplies the result of the recognition to the selection recognition section 421 and to the operation recognition section 422.

The voice recognition section 413 performs processes related to voice recognition. For example, the voice recognition section 413 recognizes the user's voice (speech content) on the basis of data regarding the voice collected by a microphone of the voice input section 212. The voice recognition section 413 supplies the result of the recognition to the selection recognition section 421 and to the operation recognition section 422.

The hand gesture recognition section 414 performs processes related to recognition of the hand gesture. For example, the hand gesture recognition section 414 recognizes the user's hand gesture on the basis of an image of the hand of the user wearing the optical see-through HMD 100, the image being captured by a hand recognition camera of the imaging section 211. The hand gesture recognition section 414 supplies the result of the recognition to the selection recognition section 421 and to the operation recognition section 422.

The head-bobbing gesture recognition section 415 performs processes related to recognition of the head-bobbing gesture. For example, the head-bobbing gesture recognition section 415 recognizes the user's head-bobbing gesture (e.g., head movement) on the basis of the result of detection by an acceleration sensor, a gyro sensor, or the like of the sensor section 213. The head-bobbing gesture recognition section 415 supplies the result of the recognition to the selection recognition section 421 and to the operation recognition section 422.

Indicated above are examples of the information used by each of the functional blocks for recognition purposes. However, these examples are not limitative of the functional blocks. These functional blocks may perform processes related to the above-described recognition on the basis of any information.

The selection recognition section 421 recognizes the operation input related to the user's selection on the basis of information regarding the recognition result supplied thereto as needed from the environment recognition section 411 to the head-bobbing gesture recognition section 415. The operation recognition section 422 recognizes the operation input related to the user's operation on the basis of information regarding the recognition result supplied thereto as needed from the environment recognition section 411 to the head-bobbing gesture recognition section 415.

The selection/operation standby definition section 431 performs processes related to the definition of operation input standby regarding selection or operation. The object definition section 432 performs processes related to the definitions of objects as operation targets. The state management section 433 manages operation-related states and updates the states as needed. The information presentation section 434 performs processes related to presentation of the information corresponding to the accepted operation input.

Incidentally, the environment recognition section 411 may be omitted, with the objects defined solely on the basis of the information defined beforehand by the object definition section 432. The environment recognition section 411 is used in a case where the environment is desired to be recognized as an AR (Augmented Reality), for example.

<Flow of the Control Process>

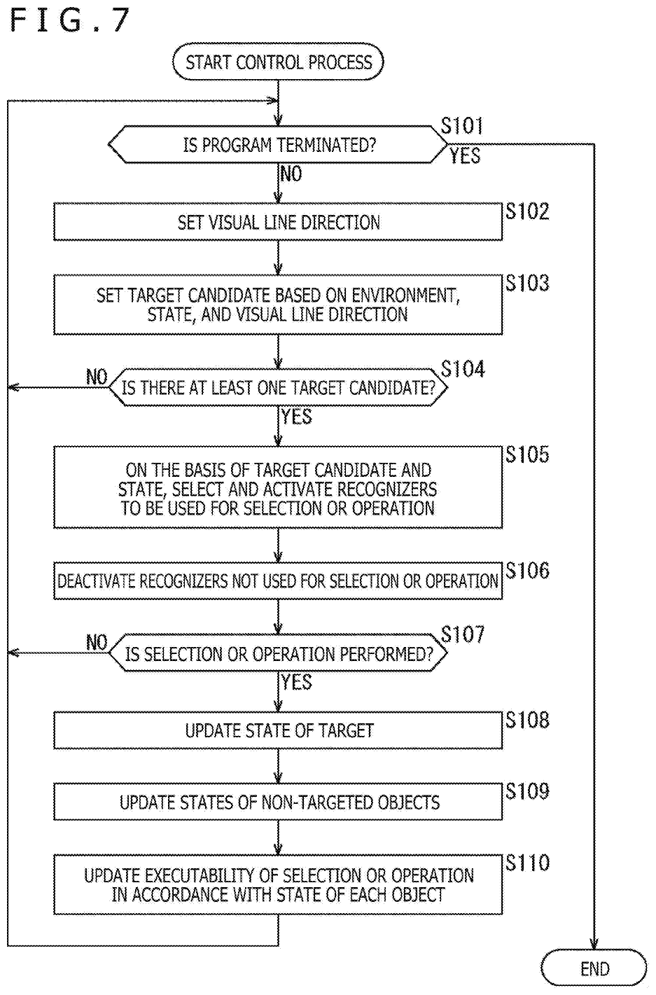

Explained below with reference to the flowchart of FIG. 7 is an exemplary flow of the control process carried out by the control section 201.

When the control process is started, the state management section 433 in the control section 201 goes to step S101 and determines whether or not the program of this control process is to be terminated. In a case where the program is determined not to be terminated, control is transferred to step S102.

In step S102, the visual line recognition section 412 recognizes and sets the visual line direction on the basis of an image captured by the visual line detection camera of the imaging section 211, for example.

In step S103, the selection recognition section 421 and the operation recognition section 422 set candidates of the target (target candidates) on the basis of the environment recognized by the environment recognition section 411, the state managed by the state management section 433, and the visual line direction set in step S102. The state management section 433 manages the state using information from the object definition section 432 and from the selection/operation standby definition section 431. That is, the state management section 433 makes use of the definition of the executability of selection or operation in the current state of each target.

In step S104, the selection recognition section 421 and the operation recognition section 422 determine whether or not there is at least one target candidate. If it is determined that there is not even a single target candidate (i.e., there exists no target candidate), control is returned to step S101 and the subsequent steps are repeated. If it is determined in step S104 that there is (i.e., there exists) at least one target candidate, control is transferred to step S105.

In step S105, the selection recognition section 421 and the operation recognition section 422 determine on, and activate (turns on), the recognizer to be used on the basis of the target candidate and the information (state) from the state management section 433. In step S106, the selection recognition section 421 and the operation recognition section 422 deactivate (turn off) the recognizers not to be used. The state management section 433 manages the state using the information from the object definition section 432 and from the selection/operation standby definition section 431. That is, the state management section 433 makes use of the definition of the recognizer to be used for selection or for operation in the current state of each target.

In step S107, it is determined whether or not selection is recognized by the selection recognition section 421 or whether or not operation is recognized by the operation recognition section 422. If it is determined that neither selection nor operation is recognized (neither selection nor operation is carried out), control is returned to step S101 and the subsequent steps are repeated. If it is determined in step S107 that selection or operation is recognized, control is transferred to step S108.

In step S108, the state management section 433 updates the state of the target subject to selection or operation. In step S109, the state management section 433 updates the states of the targets not subject to selection or operation (unselected/non-operated targets). In step S110, the state management section 433 updates the executability of selection or operation in accordance with the state of each object. The state management section 433 manages the state using the information from the object definition section 432 and from the selection/operation standby definition section 431. That is, the state management section 433 utilizes the definitions of the objects not to be selected next and of the method for selection.

Upon completion of the processing in step S110, control is returned to step S101 and the subsequent steps are repeated.

If it is determined in step S101 that the program of the control process is to be terminated, the control process is brought to an end.

When the control process is carried out as described above, the optical see-through HMD 100 can use the recognizer corresponding to the current state so as to recognize the operation input more accurately. This makes it possible to suppress omission or false recognition of minute interactions that have been difficult to recognize. That in turn contributes to implementing more natural interactions.

### 3. Second Embodiment

<Use of Rules of the Operation Input>

Suppose that upon selection of the operation target by visual line, target candidates are arrayed in the depth direction, for example. In such a case, it is difficult to select one of the target candidates on the basis of the visual line direction alone. It is difficult to identify the depth direction by visual line in the first place. Since the accuracy of recognition of the visual line direction is also relatively low, it is difficult to identify each of multiple targets by visual line alone when they are positioned in similar directions.

Thus, in a case where a first candidate and a second candidate are estimated as the candidates of the target of interest, one of the first candidate or the second candidate may be identified as the target of interest on the basis of the status information regarding the user. For example, in a state where the user is prompted to select one of multiple objects found in the user's visual line direction, some other recognizer may be used additionally to recognize another operation input. This “some other recognizer” may be any recognizer or recognizers that may include at least either the recognizer configured to recognize the user's gesture input (hand gesture input or head gesture input) or the recognizer configured to recognize the user's voice input.

In the manner described above, the optical see-through HMD 100 can select the target by a method other than that of visual line and thereby recognize the operation input more accurately.

In that case, the generally expected rules of the user's operation input may be utilized. That is, processing may be carried out on the basis of the operation input recognized by some other recognizer and in accordance with predetermined rules of the operation input.

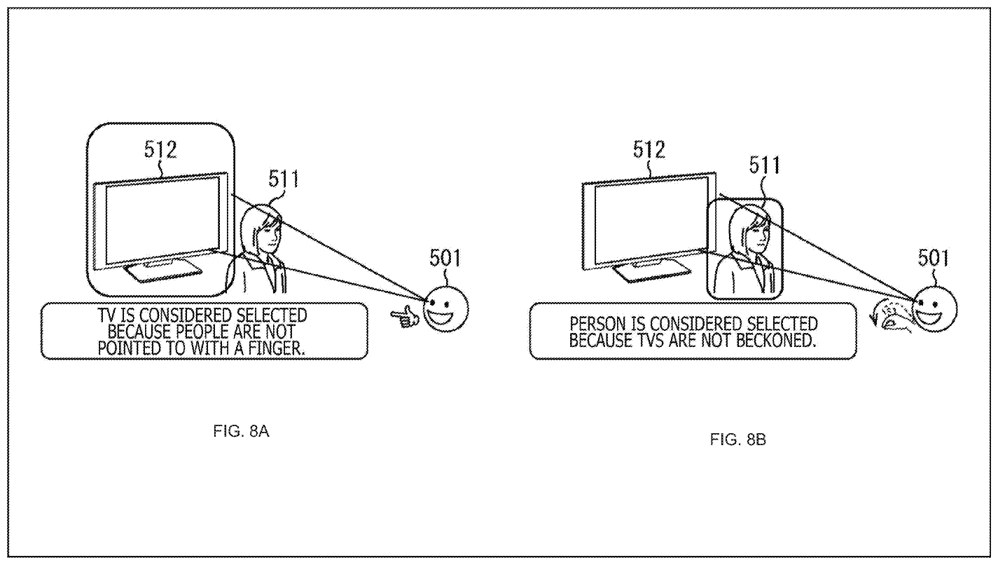

For example, as depicted in FIG. 8, it is assumed that a person 511 and a television apparatus 512 are positioned approximately in the same direction as viewed from a user 501 (the person 511 is in front of the television apparatus 512 from the viewpoint of the user 501).

Generally, there is a low possibility of the finger-pointing gesture being made at people. Also, there is generally a low possibility of a beckoning gesture being made to non-human objects. The optical see-through HMD 100 may identify the target selected by the user through the use of such rules of the hand gesture.

For example, as depicted in A in FIG. 8, suppose that a “finger-pointing” action toward the person 511 or toward the television apparatus 512 is recognized as the hand gesture made by the user 501. In that case, the optical see-through HMD 100 may determine that the television apparatus 512 is selected. In another example, as depicted in B in FIG. 8, suppose that a “beckoning” action toward the person 511 or toward the television apparatus 512 is recognized as the hand gesture made by the user 501. In this case, the optical see-through HMD 100 may determine that the person 511 is selected, i.e., that the user 501 is paying attention to the person 511. In the case where the user 501 is determined to be paying attention to the person 511, the control section 201 may deactivate the recognizers for recognizing gestures such as the hand gesture and the head gesture until the user 501 is determined to have stopped paying attention to the person 511. This prevents the gesture of the user 501 communicating with the other person from being falsely recognized as the operation input directed to a gesture-operable object. Incidentally, the determination of whether the user 501 has stopped paying attention to the person 511 may be made on the basis of whether the person 511 is no longer included in target objects, to be discussed later, or whether a “finger-pointing” action is performed as the hand gesture.

In other words, the status information regarding the user in this case includes the action information regarding the user (e.g., “beckoning” action toward the person 511 or toward the television apparatus 512) including the gesture input (including the hand gesture input). The second candidate is an object not corresponding to the operation of the control section (e.g., person 511). In a case where the gesture input recognized by the first recognizer or by the second recognizer corresponds to the first candidate, the control section may perform processes related to the first candidate. Where the recognized gesture input corresponds to the second candidate, the control section may ignore the recognized gesture.

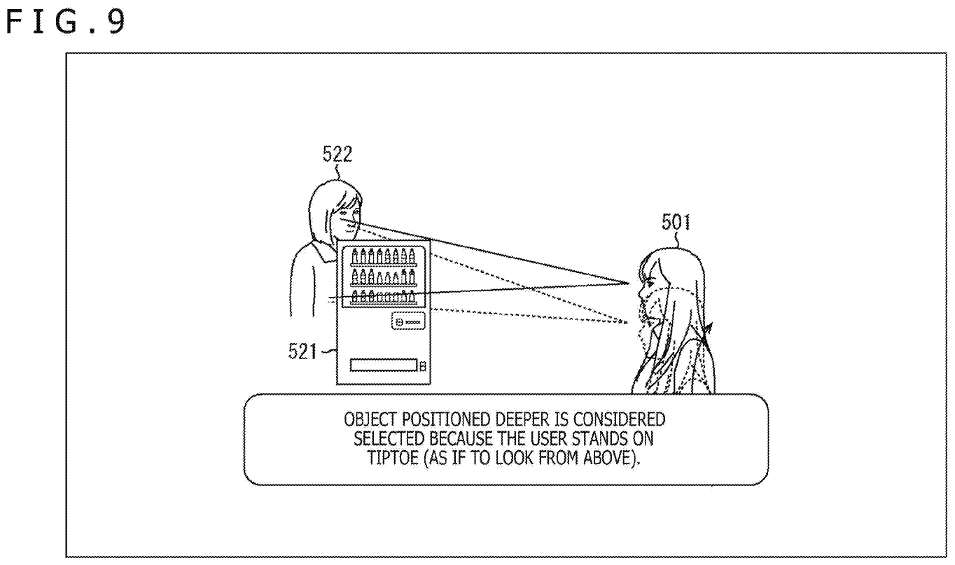

In another example, suppose that as depicted in FIG. 9, the user 501 stands on tiptoe (as if to look from above). In this case, there generally is a high possibility of the user 501 looking at not an object 521 nearby but an object 522 positioned deeper. By taking advantage of such rules of gesture, the optical see-through HMD 100 may identify the object selected by the user 501. That is, when such a stand-of-tiptoe gesture is recognized, the optical see-through HMD 100 may determine that the object 522 positioned deeper is selected.

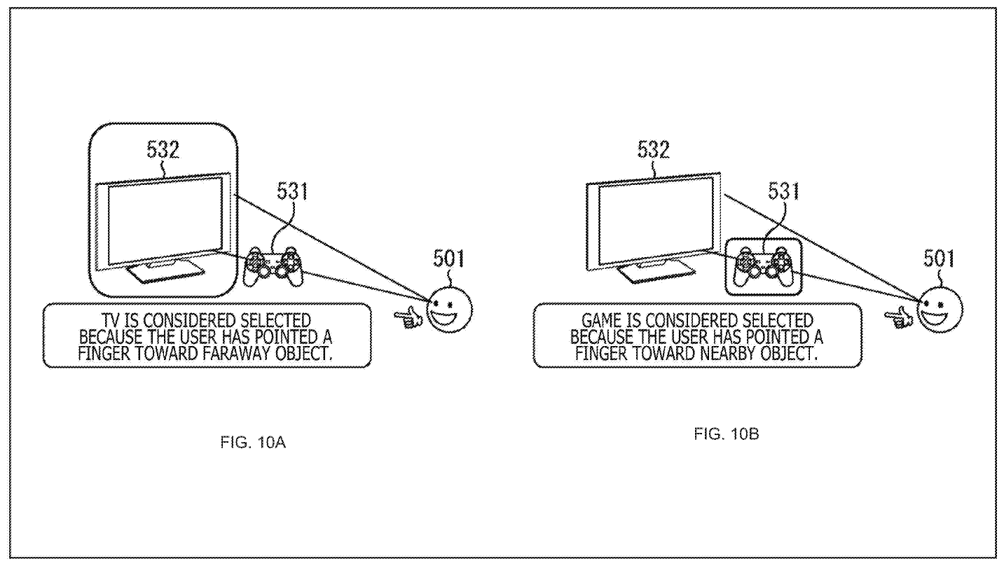

Further, there are rules of the “finger-pointing” action as the hand gesture. The status information regarding the user may include the user's action information including the gesture input. The control section 201 may then identify one of the first candidate or the second candidate as the target of interest on the basis of the distance suggested by the gesture input, a first positional relation, and a second positional relation. For example, in the case of a “finger-pointing” action for designating (selecting) a faraway object, the user 501 stretches out his or her arm. In another example, in the case of a “finger-pointing” action for designating (selecting) a nearby object, the user 501 brings the finger-pointing hand downward. Taking advantage of such “finger-pointing” rules, the optical see-through HMD 100 may identify the target designated (selected) by the user 501. For example, suppose that a hand gesture made by the user 501 is recognized as a “finger-pointing” action involving the stretching-out of the user's arm as depicted in A in FIG. 10. In that case, the optical see-through HMD 100 may determine that the television apparatus 532 positioned deeper is designated (selected). In another example, where a hand gesture made by the user 501 is recognized as a “finger-pointing” action involving the bringing-down of the user's arm as depicted in B in FIG. 10, the optical see-through HMD 100 may determine that a controller 531 nearby is designated (selected).

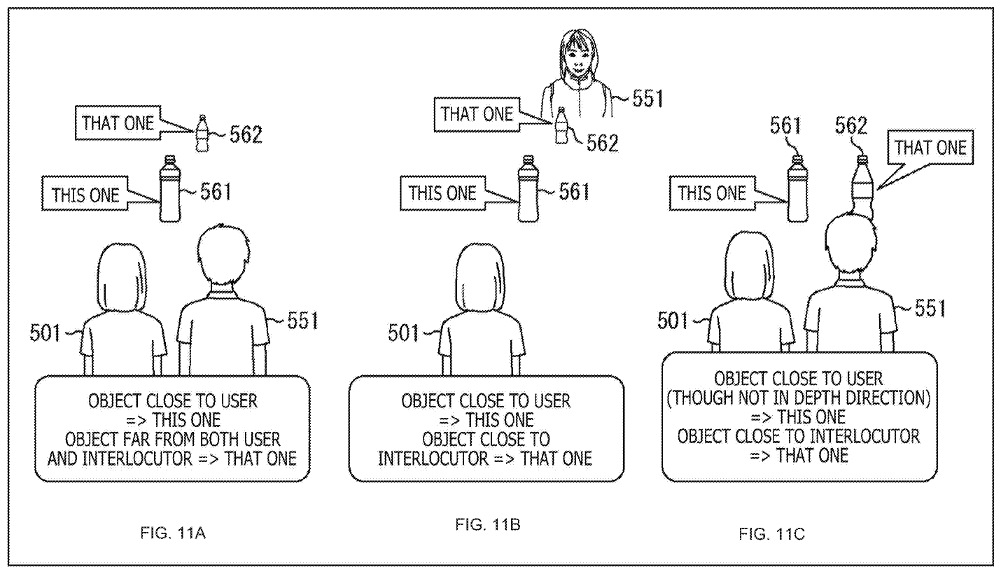

Further, the voiced directives have rules dictating that their expression vary with positional relation. For example, as depicted in A in FIG. 11, the user 501 expresses an object 561 close to the user as “this one” and an object 562 far from both the user and an interlocutor 551 as “that one.”

In anther example, as depicted in B in FIG. 11, the user 501 expresses the object 561 close to the user and far from the interlocutor 551 as “this one” and the object 562 far from the user and close to the interlocutor 551 as “that one.”

In a further example, as depicted in C in FIG. 11, in a direction different from the depth direction, the user 501 also expresses the object 561 close to the user and away from the interlocutor 551 as “this one” and the object 562 far from the user and close to the interlocutor 551 as “that one.”

The optical see-through HMD 100 may identify the target selected by the user 501 from the recognized voice by taking advantage of the rules of such directives. That is, the status information regarding the user may include the user's position information. The control section 201 may then identify one of the first candidate or the second candidate as the target of interest in accordance with the first positional relation between the user and the first candidate and the second positional relation between the user and the second candidate on the basis of the position information regarding the user. In another example, the status information regarding the user may include the user's action information including the voice input. The control section may identify one of the first candidate or the second candidate as the target of interest on the basis of the directive included in the voice input, the first positional relation, and the second positional relation. The directive may be “this one,” “that one,” or “there,” for example.

By taking advantage of the rules of the operation input as described above, the optical see-through HMD 100 can recognize the operation input more accurately.

<Functions>

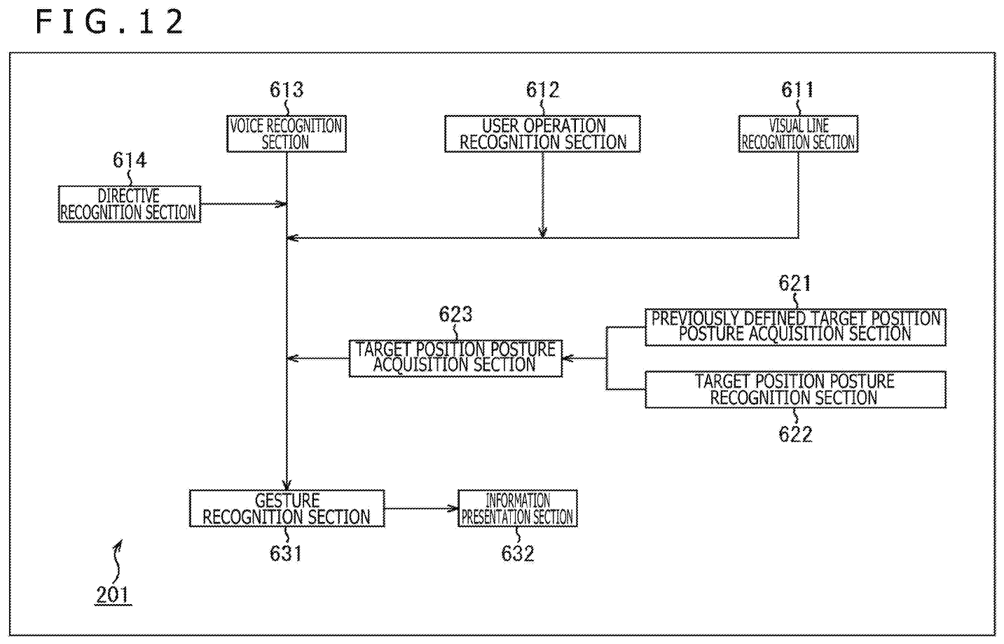

FIG. 12 depicts examples of the functional blocks representing the principal functions implemented by the control section 201 in the above case. That is, the control section 201 implements the functions indicated as the functional blocks in FIG. 12 through execution of programs.

As depicted in FIG. 12, through execution of programs, the control section 201 provides the functions of a visual line recognition section 611, a user operation recognition section 612, a voice recognition section 613, a directive recognition section 614, a previously defined target position posture acquisition section 621, a target position posture recognition section 622, a target position posture acquisition section 623, a gesture recognition section 631, and an information presentation section 632, for example.

The visual line recognition section 611 performs processes related to recognition of the user's visual line. The user operation recognition section 612 performs processes related to recognition of the user's action. The voice recognition section 613 performs processes related to recognition of the voice. The directive recognition section 614 performs processes related to recognition of the directive included in the recognized voice. The previously defined target position posture acquisition section 621 performs processes related to acquisition of a previously defined target position posture. The target position posture recognition section 622 performs processes related to recognition of a target position posture. The target position posture acquisition section 623 performs processes related to acquisition of the target position posture. The gesture recognition section 631 performs processes related to recognition of the gesture. The information presentation section 632 performs processes related to presentation of information.

These recognition sections perform their respective recognition processes on the basis of the information detected by the imaging section 211, by the voice input section 212, or by the sensor section 213.

<Flow of the Control Process>

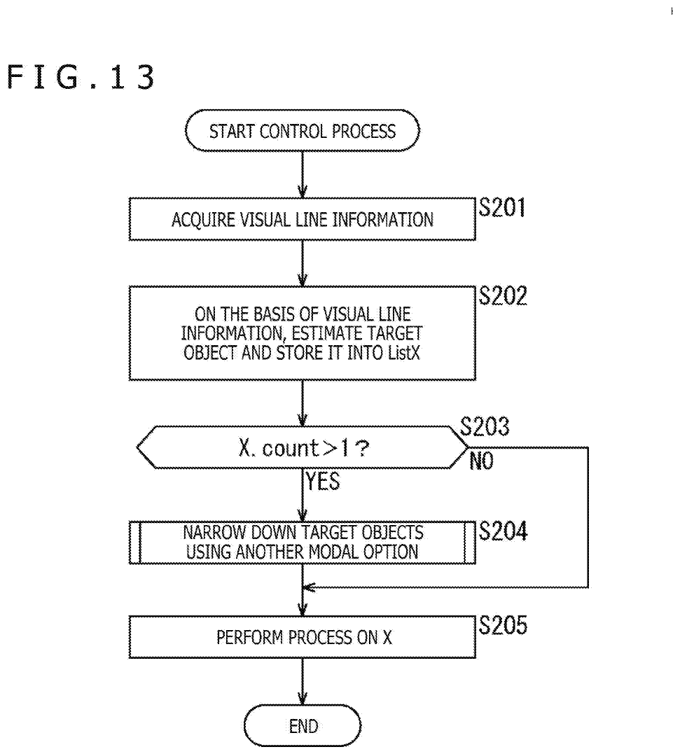

An exemplary flow of the control process executed by the above-described control section 201 is explained below with reference to the flowchart in FIG. 13.

When the control process is started, the visual line recognition section 611 in the control section 201 goes to step S201 and acquires visual line information. The target position posture acquisition section 623 sets the positions and postures of targets near the optical see-through HMD 100 on the basis of previously defined information regarding the target position posture read from the storage section 223 or the like by the previously defined target position posture acquisition section 621 and in accordance with the target position posture recognized by the target position posture recognition section 622.

In step S202, on the basis of the visual line information and the position and posture information or the like acquired in step S201, the gesture recognition section 631 estimates target objects likely to have been selected by visual line and stores all estimated target objects into ListX.

In step S203, the gesture recognition section 631 determines whether or not there are multiple target objects (X). If it is determined that there exist multiple target objects, control is transferred to step S204. In step S204, the gesture recognition section 631 narrows down the target objects using another modal option (using another recognition section). Upon completion of the processing in step S204, control is transferred to step S205. If it is determined in step S203 that there is a single target object (X), control is transferred to step S205.

In step 205, the gesture recognition section 631 performs processes on the target object (X). Upon completion of the processing in step S205, the control process is terminated.

<Flow of the Narrowing-Down Process>

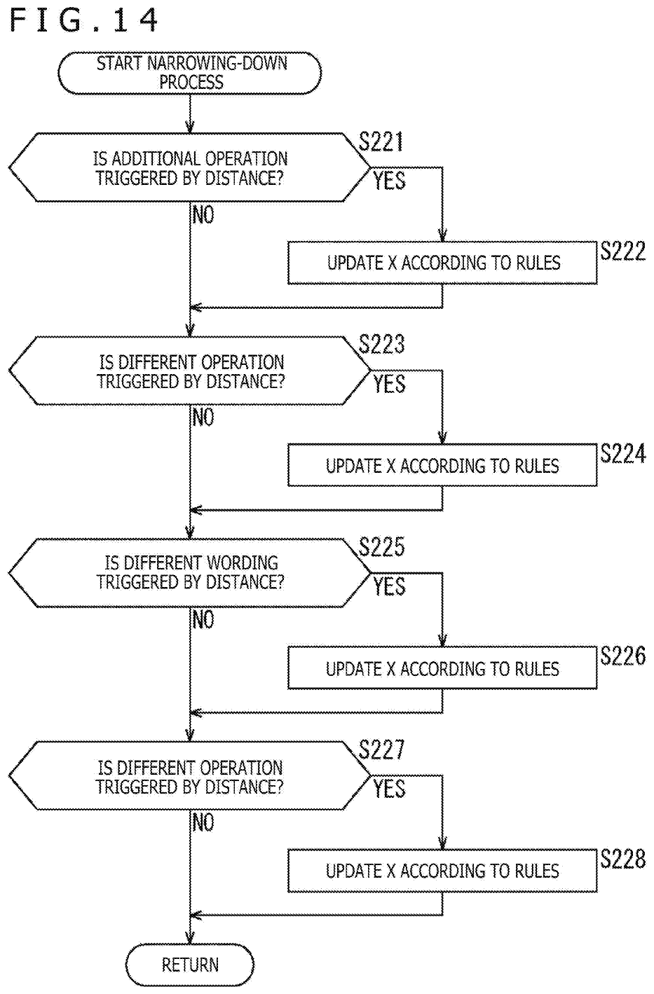

Explained below with reference to the flowchart of FIG. 14 is an exemplary flow of the narrowing-down process executed in step S204 in FIG. 13.

When the narrowing-down process is started, the gesture recognition section 631 goes to step S221 and determines whether or not an additional operation is triggered by distance. If it is determined that an additional operation is triggered by distance, control is transferred to step S222.

In step S222, the gesture recognition section 631 updates the target objects (X) in accordance with the additional operation and its rules recognized by the user operation recognition section 612. Upon completion of the processing in step S222, control is transferred to step S223. If it is determined in step S221 that an additional operation is not triggered by distance, control is transferred to step S223.

In step S223, the gesture recognition section 631 determines whether or not a different operation is triggered by distance. If it is determined that a different operation is triggered by distance, control is transferred to step S224.

In step S224, the gesture recognition section 631 updates the target objects (X) in accordance with the operation and its rules recognized by the user operation recognition section 612. Upon completion of the processing in step S224, control is transferred to step S225. If it is determined in step S223 that a different operation is not triggered by distance, control is transferred to step S225.

In step S225, the gesture recognition section 631 determines whether or not different wording is triggered by distance. If it is determined that different wording is triggered by distance, control is transferred to step S226.

In step S226, the gesture recognition section 631 updates the target objects (X) in accordance with the wording and its rules recognized by the directive recognition section 614. Upon completion of the processing in step S226, control is transferred to step S227. If it is determined in step S225 that different wording is not triggered by distance, control is transferred to step S227.

In step S227, the gesture recognition section 631 determines whether or not a different operation is triggered by target. If it is determined that a different operation is triggered by target, control is transferred to step S228.

In step S228, the gesture recognition section 631 updates the target objects (X) in accordance with the operation and its rules recognized by the user operation recognition section 612. Upon completion of the processing in step S228, the narrowing-down process is terminated and control is returned to FIG. 13. If it is determined in step S227 that different wording is not triggered by target, the narrowing-down process is terminated and control is returned to FIG. 13.

By performing each of the steps as described above, the optical see-through HMD 100 can recognize the operation input more accurately through the use of the rules of the operation input. This makes it possible to suppress omission or false recognition of minute interactions that have been difficult to recognize. That in turn contributes to implementing more natural interactions.

### 4. Other Examples of Application

<Other Devices>

Explained above is the example in which the present technology is applied to the optical see-through HMD 100. This technology may also be applied to any apparatus that recognizes the operation input. That is, the above example is not limitative of the devices and systems to which the present technology can be applied.

For example, the present technology may be applied to a video see-through HMD acting as an AR-HMD (Augmented Reality-HMD) that captures images of the real space and presents the user with the captured images of the real space displayed on a monitor. Applying the present technology to the video see-through HMD thus provides advantages similar to those of the above-described optical see-through HMD 100.

In another example, the present technology may be applied to a VR-HMD (Virtual Reality-HMD) that allows the user to recognize not the real space but a virtual space. That is, the operation target to be identified on the basis of the user's action may be an object in the virtual space. Applying the present technology to the VR-HMD thus provides advantages similar to those of the above-described optical see-through HMD 100.

Further, the present technology may be applied to devices or systems other than the HMD. For example, this technology may be applied to a system having sensor devices installed away from the user (e.g., camera and microphone) to detect information including the user's operation input (e.g., action, visual line, and voice), the system further recognizing the user's operation input included in the detected information, before causing a process corresponding to the operation input to be performed by an output device independent of the sensor devices. Such a system may display desired images on a monitor as the process corresponding to the operation input, execute processes so as to act as a voice agent using speakers, or control projection mapping using a projector, for example. In this case, the operation target identified on the basis of the user's action may be an object in the real space or an object in the virtual space. Applying the present technology to the above system thus provides advantages similar to those of the above-described optical see-through HMD 100.

In the case above, any sensors may be used to detect the user's action. The sensors may be other than the imaging apparatus. For example, the user may wear a wearable device such as a wristband or a neckband equipped with sensors such as acceleration sensors for detecting the user's action. That is, the user may act and speak while wearing the wearable device so as to be presented with voices and images by other devices (e.g., monitor and speaker).

### 5. Others

<Software>

The series of the processes described above may be executed either by hardware or by software. Alternatively, some of the processing may be performed by hardware and the rest by software. In the case where the series of the above-described processes is to be executed by software, the programs constituting the software are installed from a network or from a recording medium.

In the case of the optical see-through HMD 100 in FIG. 2, for example, the recording medium includes the removable medium 231 on which programs and other resources are recorded and which are distributed to users apart from the apparatus proper in order to deliver the recorded programs. In such a case, the removable medium 231 on which the programs are recorded may be loaded into the drive 225 so as to have the programs installed into the storage section 223 following their retrieval from the loaded medium.

Alternatively, the programs may be distributed via wired or wireless transmission media including local area networks, the Internet, and digital satellite broadcasts. In the case of the optical see-through HMD 100 in FIG. 2, for example, the programs may be received through the communication section 224 before being installed into the storage section 223.

As another alternative, the programs may be preinstalled in a storage section or in a ROM. In the case of the optical see-through HMD 100 in FIG. 2, for example, the programs may be preinstalled in the storage section 223 or in a ROM within the control section 201.

<Supplementary Notes>

The embodiments of the present technology are not limited to those discussed above and may be modified or altered diversely within the scope of this technology.

For example, the present technology may be implemented in the form of apparatuses or systems of every configuration, such as a processor in system LSI (Large Scale Integration) form, a module using multiple processors, a unit using multiple modules, or a set of the unit equipped with additional functions (i.e., configured as part of apparatus).

In another example, each of the blocks or the functional blocks discussed above may be implemented in any configuration as long as each block or each functional block provides the above-described function attributed thereto. For example, a given block or functional block may be configured with any circuit, LSI, system LSI, processor, module, unit, set, device, apparatus, or system. These configurations may be used in combination. For example, configurations of the same type may be used in combination, such as multiple circuits or multiple processors being combined. Alternatively, configurations of different types may be used in combination, such as circuits and LSIs being combined.

In this description, the term “system” refers to an aggregate of multiple components (e.g., apparatuses or modules (parts)). It does not matter whether or not all components are housed in the same enclosure. Thus, a system may be configured with multiple apparatuses housed in separate enclosures and interconnected via a network, or with a single apparatus in a single enclosure that houses multiple modules.

In another example, the configuration explained above as a single apparatus (or a block or a functional block) may be divided into multiple apparatuses (or blocks or functional blocks). Conversely, the configurations explained above as multiple apparatuses (or blocks or functional blocks) may be integrated into a single apparatus (or a block or a functional block). Obviously, the configuration of each apparatus (or each block or functional block) may be additionally furnished with a configuration other than those discussed above. Further, if the configuration or operation of an entire system remains substantially the same, part of the configuration of a given apparatus (or a block or a functional block) in the system may be included in the configuration of another apparatus (or another block or functional block) therein.

In yet another example, the present technology may be implemented as a cloud computing setup in which a single function is processed cooperatively by multiple networked devices on a shared basis.

In a further example, the above-described programs may be executed by any apparatus. In this case, the apparatus need only have the necessary function (functional block) for obtaining necessary information.

Also, each of the steps discussed above in reference to the above-described flowcharts may be executed either by a single apparatus or by multiple apparatuses on a shared basis. Furthermore, if a single step includes multiple processes, these processes may be executed either by a single apparatus or by multiple apparatuses on a shared basis. In other words, multiple processes included in a single step may be executed as a process of multiple steps. Conversely, the process explained as multiple steps may be executed collectively as a single step.

The programs to be executed by the computer may each be processed chronologically, i.e., in the sequence depicted in this description, in parallel with other programs, or in otherwise appropriately timed fashion such as when the program is invoked as needed. That is, the above steps may be carried out in sequences different from those discussed above as long as there is no inconsistency between the steps. Furthermore, the processes of the steps describing a given program may be performed in parallel with, or in combination with, the processes of other programs.

The multiple techniques discussed in this description may each be implemented independently of the others as long as there is no inconsistency therebetween. Obviously, any number of these techniques may be implemented in combination. For example, some or all of the techniques discussed in conjunction with one embodiment may be implemented in combination with some or all of the techniques explained in connection with another embodiment. Further, some or all of any of the techniques discussed above may be implemented in combination with another technique not described above.

The present technology may be implemented preferably in the following configurations:

(1) An information processing apparatus including:

a control section performing a process on a target of interest on the basis of the target of interest and one of a first recognizer or a second recognizer, the target of interest being identified on the basis of status information regarding a user including at least either action information or position information regarding the user, the first recognizer being configured to recognize an operation input of the user, the second recognizer being configured to be different from the first recognizer and to recognize the operation input of the user.

(2) The information processing apparatus as stated in paragraph (1) above,

in which the first recognizer includes a recognizer not included in the second recognizer, and

the second recognizer includes a recognizer not included in the first recognizer.

(3) The information processing apparatus as stated in paragraph (2) above,

in which the control section activates one of the first recognizer or the second recognizer and deactivates the other recognizer on the basis of the identified target of interest, the control section further performing the process on the target of interest on the basis of the activated recognizer.

(4) The information processing apparatus as stated in paragraph (3) above,

in which the operation input of the user includes a voice input of the user,

the activated recognizer includes a recognizer configured to recognize the voice input, and

if the identified target of interest is operable by voice, the control section performs the process on the target of interest on the basis of the voice input recognized by the activated recognizer.

(5) The information processing apparatus as stated in paragraph (4) above,

in which the operation input of the user includes a head gesture input of the user,

the activated recognizer includes a recognizer configured to recognize the head gesture input, and

if the identified target of interest is operable by voice, the control section uses the activated recognizer to recognize the head gesture input and the voice input, the control section further performing the process on the target of interest on the basis of either the recognized head gesture input or the recognized voice input.

(6) The information processing apparatus as stated in paragraph (5) above,

in which the control section performs a first process corresponding to the head gesture input in preference over a second process corresponding to the voice input.

(7) The information processing apparatus as stated in paragraph (6) above,

in which, if the activated recognizer recognizes the head gesture input, the control section performs the process on the basis of the head gesture input, and

if the activated recognizer does not recognize the head gesture input, the control section performs the process on the basis of the voice input recognized by the activated recognizer.

(8) The information processing apparatus as stated in any one of paragraphs (4) to (7) above,

in which the voice input solely includes an answer particle.

(9) The information processing apparatus as stated in any one of paragraphs (4) to (8) above,

in which the operation input of the user includes a hand gesture input of the user, and

the deactivated recognizer includes a recognizer configured to recognize the hand gesture input.

(10) The information processing apparatus as stated in paragraph (9) above, in which the voice input includes a directive, and if the activated recognizer recognizes the directive, the control section activates the deactivated recognizer configured to recognize the hand gesture input of the user.

(11) The information processing apparatus as stated in any one of paragraphs (1) to (10) above,

in which, if a first candidate and a second candidate are estimated as the target of interest, the control section identifies one of the first candidate or the second candidate as the target of interest on the basis of the status information regarding the user.

(12) The information processing apparatus as stated in paragraph (11) above,

in which the status information regarding the user includes action information regarding the user including a gesture input,

the second candidate is an object not corresponding to an operation performed by the control section, and

the control section performs the process on the first candidate if the gesture input recognized by either the first recognizer or the second recognizer corresponds to the first candidate, the control section further ignoring the recognized gesture if the recognized gesture input corresponds to the second candidate.

(13) The information processing apparatus as stated in paragraph (12) above,

in which the gesture input includes a hand gesture input.

(14) The information processing apparatus as stated in any one of paragraphs (11) to (13) above,

in which the status information regarding the user includes position information regarding the user, and

the control section identifies one of the first candidate or the second candidate as the target of interest on the basis of a first positional relation between the user and the first candidate and a second positional relation between the user and the second candidate in accordance with the position information regarding the user.

(15) The information processing apparatus as stated in paragraph (14) above,

in which the status information regarding the user includes action information regarding the user including a gesture input, and

the control section identifies one of the first candidate or the second candidate as the target of interest on the basis of a distance suggested by the gesture input, the first positional relation, and the second positional relation.

(16) The information processing apparatus as stated in paragraph (14) above,

in which the status information regarding the user includes action information regarding the user including a voice input, and

the control section identifies one of the first candidate or the second candidate as the target of interest on the basis of a directive included in the voice input, the first positional relation, and the second positional relation.

(17) The information processing apparatus as stated in any one of paragraphs (1) to (16) above,

in which the target of interest includes an object in a virtual space, the object being displayed on a display section.

(18) The information processing apparatus as stated in paragraph (17) above,

in which the information processing apparatus includes a display apparatus further having the display section.

(19) The information processing apparatus as stated in any one of paragraphs (1) to (18) above,

in which the control section identifies the target of interest on the basis of an image captured of the real space by an imaging section.

(20) An information processing method including:

by an information processing apparatus, performing a process on a target of interest on the basis of the target of interest and one of a first recognizer or a second recognizer, the target of interest being identified on the basis of status information regarding a user including at least either action information or position information regarding the user, the first recognizer being configured to recognize an operation input of the user, the second recognizer being configured to be different from the first recognizer and to recognize the operation input of the user.

### REFERENCE SIGNS LIST

100 Optical see-through HMD
111 Housing
112 Display section
113 Hole
131 Housing
132 Display section
133 Hole
151 Cable
152 Control box
201 Control section
211 Imaging section
212 Voice input section
213 Sensor section
214 Display section
215 Voice output section
216 Information presentation section
221 Input section
222 Output section
223 Storage section
224 Communication section
225 Drive
231 Removable medium
411 Environment recognition section
412 Visual line recognition section
413 Voice recognition section
414 Hand gesture recognition section
415 Head-bobbing gesture recognition section
421 Selection recognition section
422 Operation recognition section
431 Selection/operation standby definition section
432 Object definition section
433 State management section
434 Information presentation section
611 Visual line recognition section
612 User operation recognition section
613 Voice recognition section
614 Directive recognition section
621 Previously defined target position posture acquisition section
622 Target position posture recognition section
623 Target position posture acquisition section
631 Gesture recognition section
632 Information presentation section

1. An information processing apparatus comprising:
a control section performing a process on a target of interest on a basis of the target of interest and one of a first recognizer or a second recognizer, the target of interest being identified on a basis of status information regarding a user including at least either action information or position information regarding the user, the first recognizer being configured to recognize an operation input of the user, the second recognizer being configured to be different from the first recognizer and to recognize the operation input of the user.

2. The information processing apparatus according to claim 1,
wherein the first recognizer includes a recognizer not included in the second recognizer, and
the second recognizer includes a recognizer not included in the first recognizer.

3. The information processing apparatus according to claim 2,
wherein the control section activates one of the first recognizer or the second recognizer and deactivates the other recognizer on a basis of the identified target of interest, the control section further performing the process on the target of interest on a basis of the activated recognizer.

4. The information processing apparatus according to claim 3,
wherein the operation input of the user includes a voice input of the user,
the activated recognizer includes a recognizer configured to recognize the voice input, and
if the identified target of interest is operable by voice, the control section performs the process on the target of interest on a basis of the voice input recognized by the activated recognizer.

5. The information processing apparatus according to claim 4,
wherein the operation input of the user includes a head gesture input of the user,
the activated recognizer includes a recognizer configured to recognize the head gesture input, and
if the identified target of interest is operable by voice, the control section uses the activated recognizer to recognize the head gesture input and the voice input, the control section further performing the process on the target of interest on a basis of either the recognized head gesture input or the recognized voice input.

6. The information processing apparatus according to claim 5,
wherein the control section performs a first process corresponding to the head gesture input in preference over a second process corresponding to the voice input.

7. The information processing apparatus according to claim 6,
wherein, if the activated recognizer recognizes the head gesture input, the control section performs the process on a basis of the head gesture input, and
if the activated recognizer does not recognize the head gesture input, the control section performs the process on a basis of the voice input recognized by the activated recognizer.

8. The information processing apparatus according to claim 4,
wherein the voice input solely includes an answer particle.

9. The information processing apparatus according to claim 4,
wherein the operation input of the user includes a hand gesture input of the user, and
the deactivated recognizer includes a recognizer configured to recognize the hand gesture input.

10. The information processing apparatus according to claim 9,
wherein the voice input includes a directive, and
if the activated recognizer recognizes the directive, the control section activates the deactivated recognizer configured to recognize the hand gesture input of the user.

11. The information processing apparatus according to claim 1,
wherein, if a first candidate and a second candidate are estimated as the target of interest, the control section identifies one of the first candidate or the second candidate as the target of interest on the basis of the status information regarding the user.

12. The information processing apparatus according to claim 11,
wherein the status information regarding the user includes action information regarding the user including a gesture input,
the second candidate is an object not corresponding to an operation performed by the control section, and
the control section performs the process on the first candidate if the gesture input recognized by either the first recognizer or the second recognizer corresponds to the first candidate, the control section further ignoring the recognized gesture if the recognized gesture input corresponds to the second candidate.

13. The information processing apparatus according to claim 12,
wherein the gesture input includes a hand gesture input.

14. The information processing apparatus according to claim 11,
wherein the status information regarding the user includes position information regarding the user, and
the control section identifies one of the first candidate or the second candidate as the target of interest on a basis of a first positional relation between the user and the first candidate and a second positional relation between the user and the second candidate in accordance with the position information regarding the user.

15. The information processing apparatus according to claim 14,
wherein the status information regarding the user includes action information regarding the user including a gesture input, and
the control section identifies one of the first candidate or the second candidate as the target of interest on a basis of a distance suggested by the gesture input, the first positional relation, and the second positional relation.

16. The information processing apparatus according to claim 14,
wherein the status information regarding the user includes action information regarding the user including a voice input, and
the control section identifies one of the first candidate or the second candidate as the target of interest on a basis of a directive included in the voice input, the first positional relation, and the second positional relation.

17. The information processing apparatus according to claim 1,
wherein the target of interest includes an object in a virtual space, the object being displayed on a display section.

18. The information processing apparatus according to claim 17,
wherein the information processing apparatus includes a display apparatus further having the display section.

19. The information processing apparatus according to claim 1,
wherein the control section identifies the target of interest on a basis of an image captured of the real space by an imaging section.

20. An information processing method comprising:
by an information processing apparatus, performing a process on a target of interest on a basis of the target of interest and one of a first recognizer or a second recognizer, the target of interest being identified on a basis of status information regarding a user including at least either action information or position information regarding the user, the first recognizer being configured to recognize an operation input of the user, the second recognizer being configured to be different from the first recognizer and to recognize the operation input of the user.
